(19) United States
(12) Patent Application Publication
(10) Pub. No.: US 2009/0144125 A1
(43) Pub. Date: Jun. 4, 2009

(54) SYSTEM AND METHOD FOR RECONNAISSANCE FOR SPEND MANAGEMENT PROCUREMENT

(75) Inventors: Satadal Bandyopadhyay, Bangalore (IN); Amit Tambi, Bangalore (IN); Sharad Kulshrestha, Bangalore (IN); Sumit Patnaik, Bangalore (IN); Lakshmi Raghava Dhenuvakonda, Bangalore (IN); Gopikrishnan Gouri Ramachandran, Bangalore (IN)

Correspondence Address: NIXON PEABODY, LLP, 401 9TH STREET, NW, SUITE 900, WASHINGTON, DC, 20004-2128, US

(73) Assignee: Infosys Technologies, Ltd., Bangalore (IN)

(21) Appl. No.: 11/949,911

(22) Filed: Dec. 4, 2007

(51) Int. Cl. G06F 17/00; G06Q 10/00

(52) U.S. Cl. 705/10; 705/7

(57) ABSTRACT

A system, method and computer program product for providing a procurement solution, including determining a maturity level of a strategic direction, procurement processes, and procurement information technology (IT) landscape of a client; identifying a prescription to a spend management solution product, based on the determined maturity level, procurement processes, and procurement IT landscape of the client; and deploying the spend management solution product for the client based on the identified prescription to the spend management solution product.

### BACKGROUND OF THE INVENTION

### FIELD OF THE INVENTION

The present invention generally relates to the field of business management software systems, and more particularly, to systems and methods for providing procurement solutions.

### DISCUSSION OF THE BACKGROUND

Spend management is the way in which companies monitor, control and optimize the money they spend. It involves cutting operating and other costs associated with doing business. These costs typically show up as “operating costs” or SG&A (Selling, General and Administrative) costs, but can also be found in other areas and in other members of the supply chain.

A supply chain, logistics network, or supply network may be referred to a coordinated system of organizations, people, activities, information and resources involved in moving a product or service in physical or virtual manner from supplier to customer. Supply chain activities (i.e., value chains or life cycle processes) transform raw materials and components into a finished product that is delivered to the end customer. The ever increasing technical complexity of standard consumer goods, combined with the ever increasing size and depth of the global market implies that the link between consumer and vendor is usually only the final link in a long and complex chain or network of exchanges. For example, the supply chain may begin with the extraction of raw material and include several production links—component construction, assembly and merging, before moving onto several layers of storage facilities of ever decreasing size, ever more remote geographical locations, and finally reaching the consumer.

Thus, supply chains are increasingly becoming more complex and dynamic. The success of a business largely depends on the success of the supply chain, and the business's ability to effectively manage its spending. Whether it is the money spent on goods or services for direct inputs (raw goods and materials used in the manufacture of products), indirect material (office supplies and other expenses that do not go into a finished product), or services (temporary and contract labor, print services, etc.), a company needs a mechanism by which it not only has the opportunity to save money but also control costs. Spend management comprises a host of activities involved in the “source-to-pay” process—requisition review and processing, supplier identification, designing the RFX, negotiations, contract formulation, purchase order processing, contract execution, contract compliance, accounts payment and settlement and Spend data analysis to identify the potential saving opportunities. The last step in particular is of strategic importance due to opportunities for optimizing supply chain activities.

Spend management solutions have been developed in order to help companies analyze, understand, and manage their corporate spending to achieve increased cost savings and business process efficiency. Leaner supply chains may be obtained, for example, through process and Information Technology (IT) related interventions in planning, execution, monitoring and collaboration. Supply chain management solutions may be designed to address specific supply chain management processes. Some examples of supply chain management solutions include custom applications products, such as i2, Manugistics, Oracle APS, Yantra, Ariba, and SAP APO. Thus, an entity for providing supply chain management solutions may work with optimization experts, leading academics and numerous clients in a variety of industries to develop and fine tune planning, optimization, and execution of supply chain management solutions, thereby delivering valuable benefits to another entity, such as clients, in nearly every industry and geography worldwide.

Hence, as competition in the procurement arena intensifies, organizations may desire to improve their effectiveness by managing spend and accelerating process performance. Thus, a comprehensive spend management solution, for example, one that delivers cross-company spend visibility, promotes accurate decision making, and employs best practices on which to refine and grow an efficient procurement infrastructure may be further desired. Leading spend management and Supplier Relationship Management (SRM) packages, such as SAP-SRM, Ariba, and Oracle i-Procurement have been delivered to enhance strategic and operational procurement capabilities. One spend management package—the Ariba Enterprise Spend Management Suite—comprises software, services and expertise that enable companies to rapidly master their spend and accelerate towards bottom-line success without costly customization or internal IT alignment issues. Combined with other features, such as the comprehensive, scalable Ariba Supplier Network, Ariba solutions may drive more business volume between buyers and suppliers than other spend management systems.

In an exemplary embodiment of the existing process, enterprise services for supply chain management procurement practice waits for a client's request for proposal (RFP) for a procurement project engagement. The engagement may be one or more of the following:

(1) Maintenance & Support of client's existing Ariba installation;

(2) Assessment of client's Ariba solution;

(3) Define the roadmap of Ariba for a client's procurement landscape;

(4) Implementation of an Ariba module for a client's select procurement process; and

(5) A global roll-out of an existing Ariba module.

Individuals are assigned to work on the RFP. Quality of the RFP is a direct relation to the individual's competency and their limited network. They work on the proposal and submit it accordingly. The client awards/declines the project to a provider, such as Infosys. The submitted proposal languishes in a folder. The individual moves on with their project. As a result, the business process perspective which is developed while working in these proposals is not retained as a reusable component for use either in a different proposal to the same client, or in similar proposals to other clients.

Thus, new spend management solutions, such as those incorporating Ariba engagements, are as a result of a client-push, i.e., they are driven by the client, instead of proactive or planned efforts made by the provider (say, Infosys). The described (client driven) procedures may not be applicable to the provider's scope to reach out to prospective clients and get them on-board, for example, to Ariba Spend Management suite for their procurement evolution. Furthermore, focus on request for proposal/request for information (RFP/RFI) is generally restricted to the one-off engagement as demanded by the client. Forgotten is the fact that the client may be capable of sharing a wealth of information on its procurement landscape. This information can be mined and be put to create a long term customer relationship around procurement partnership. There is no methodology in place to assess the client's procurement landscape taking into account business processes, technology maturity and industry trends & best practices. Additionally, no methodology may be in place to turn the assessment into a transformational prescription on a spend management platform, such as Ariba. Moreover, client connects may be restricted to the tactical one-off engagement scope instead of a strategic one. High quality end-to-end consulting work is hard to come-by and the Supply Chain Management (SCM) Ariba practice at Infosys will not lose any opportunity to gain a valuable Ariba procurement market share.

And so, new trends signify that there is a lot of catching-up to do and, a vast scope of improvement. Thus, there exists an industry realization that there is definite business sense in going up the procurement value-chain.

### SUMMARY OF THE INVENTION

The above and other needs are addressed by the present invention which provides a method and system for providing and producing procurement solutions. In one embodiment of the present technique, a method is provided which considers the maturity level of a first entity's strategic direction, procurement processes, IT landscape to identify prescriptions based on spend management solution product. Another embodiment of the present technique, a hybrid strategy of engagement envisages a pull component and a push component which are synchronized to provide an optimal procurement prescription.

Accordingly, in exemplary aspects, the present invention provides a system, and method for determining the maturity level of a strategic direction, procurement processes, and procurement information technology (IT) landscape of a client, thereby identifying a prescription to a spend management solution product and deploying the spend management solution product for the client based on the identified prescription to the spend management solution product.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary framework of a spend management solution, according to an exemplary embodiment of the present invention;

FIG. 2 illustrates an exemplary process, according to an exemplary embodiment of the present invention; and

FIG. 3 illustrates an exemplary overview of the framework of FIG. 1 implemented in industry, according to an exemplary embodiment of the present invention.

### DETAILED DESCRIPTION OF THE PREFERRED EMBODIMENTS

The exemplary embodiments can be used for providing procurement solutions, and can include a Reconnaissance for Ariba Procurement (RAP) methodology that enables a provider, such as Infosys to partner with the client in its procurement roadmap evolution by assessing and building a transformational prescription on the Ariba platform. An innovation for profit, RAP is aimed at achieving business progression and value-chain progression. While disclosed embodiments utilize the Ariba platform to assess and build the transformational prescription, as detailed herein, it should be appreciated that the Ariba platform is for illustrative purposes and, further, that the disclosure should not be limited to any one platform. Other spend management solutions platforms or other appropriate spend management and SRM packages including, for example, i2, SAP SRM, Oracle i-Procurement, Emptoris, Procuri and the like, may be employed in exemplary embodiments.

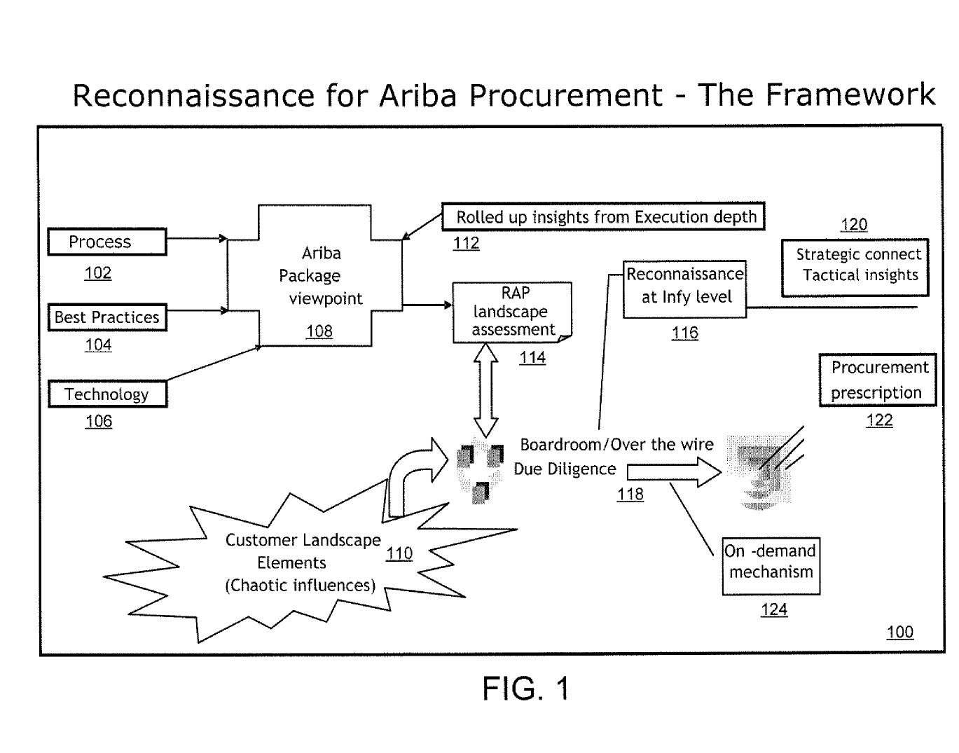

Referring to the drawings, wherein like reference numerals designate identical or corresponding parts throughout the several views, and more particularly to FIGS. 1-3 thereof which will be used to illustrate exemplary embodiments of the present invention.

Turning to FIG. 1, an exemplary framework 100 is illustrated for reconnaissance for Ariba procurement. An Ariba package viewpoint 108 may be configured to receive various input data for further assessment. Such data may include a process 102 for executing a prescribed plan or algorithm, for example. Best practices 104, such as within a prescribed industry, may be input. Information related to a particular technology 106 may be entered. Additionally, rolled up insights from execution depth 112 may also be received by the Ariba package viewpoint 108.

The Ariba package viewpoint 108 provides input to generate a RAP landscape assessment 114. Customer landscape elements 110 are also provided within the framework 100. In some instances, the customer landscape elements 100 may also include chaotic influences. Both components of the RAP landscape assessment 114 and the customer landscape elements 110 may be further evaluated/analyzed, such as by a boardroom 118 of a provider. If needed, this methodology can also support an over-the-wire due diligence. It is not necessary for the assessment to occur at the client's site. The service provider can perform the bulk of the assessment offsite with a thin team at the client's site, either pushed by the Provider's Engagement Lead or ‘On-Demand’ by the client 124 RAP and can take place at any point in time and is not dependent on a particular event or timing. While the boardroom level over-the-wire due-diligence is on, the service provider's offsite team is working behind the scenes to assess information to identify tactical opportunities 116 that would lead to a strategic connect. Overall, a procurement prescription 122 is provided by the disclosed framework 100.

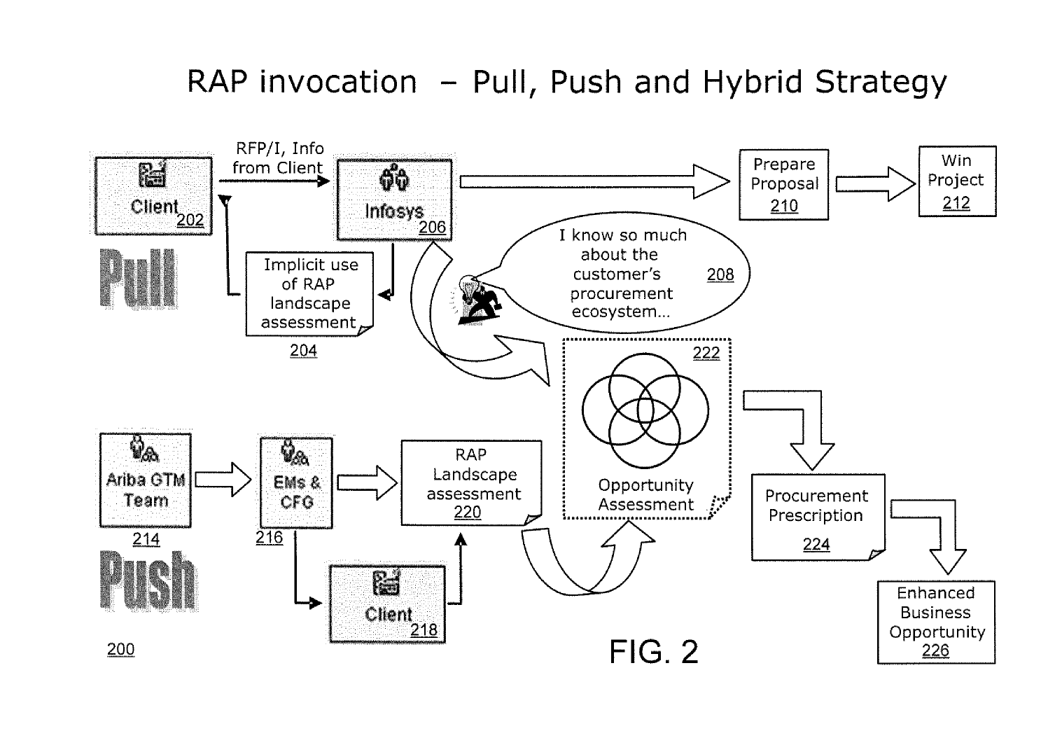

Turning to FIG. 2, a RAP invocation, i.e., a “Pull, Push and Hybrid Strategy” 200 is provided in accordance with an exemplary embodiment. The “Pull” component may include client input 202. Thus, request for proposal/request for information (RFP/I) data from the client is forwarded to a provider 206, such as Infosys (Infosys is used purely as an exemplary provider for the disclosed example. One will appreciate that other appropriate providers may also be utilized). The provider 206 may determine an implicit use of the RAP landscape assessment 204 and thereby send a portion of the assessment tool back to the client 202. In addition or alternatively, the provider may prepare a proposal 210 to win the project 212. In addition or alternatively, the provider 206 may obtain a certain prescribed knowledge of the client's requirements 208. For example, the provider can know informational data regarding a customer's procurement ecosystem, based on limited existing client engagements.

The “Push” component may include information from the Ariba Go-To-Market (CTM) Team 214 forwarded to the Engagement Managers (EM) and Client-Facing Group (CFG) 216. Thus, at least some information may be packaged and processed prior to being forwarded to the client 218. In addition or alternatively, information may be supplied directly from EMs and CFG 216 to the RAP landscape assessment 220. The RAP landscape assessment 220 may also receive select information from the client 218. An opportunity assessment 222 component is provided to also receive data from the RAP landscape assessment 220.

The different components as described above, namely the Ariba GTM team 214, Engagement Managers (EM) and Client-Facing Group (CFG) 216, The Assessment component 220, combined with the information inputs form client, 218, are fed into the opportunity assessment 222 to thus generate a procurement prescription 224 which provides an enhanced business opportunity 226.

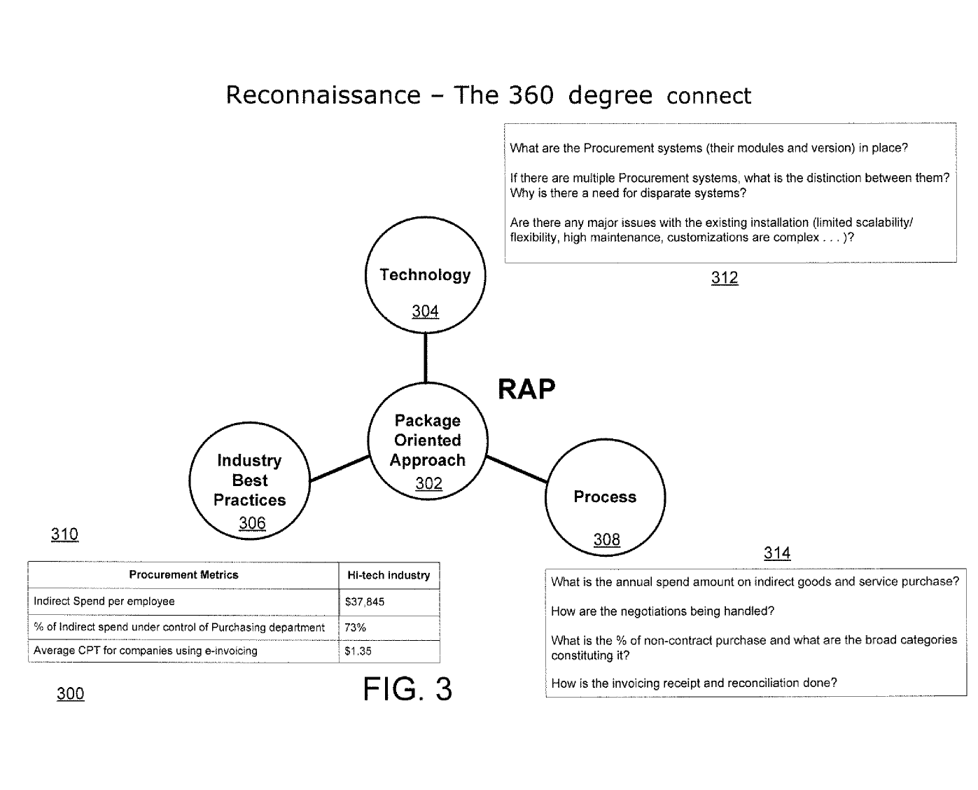

Thus, as shown in FIG. 3, the reconnaissance provides a 360 degree connect methodology 300. A package oriented approach 302 is provided which may include components provided through technology 304, industry best practices 306 and process 308.

In an exemplary embodiment, the technology 304 component may include information 312 generated through a series of analysis. Such analysis may include questions pertaining to procurement IT systems, such as “What are the procurement systems (e.g. their modules and versions) in place?”, “If there are multiple procurement systems, what is the distinction between them?”, “Why is there a need for disparate systems?”, “Are there any major issues with the existing installation (limited scalability/flexibility, high maintenance, customizations are complex, etc.?”.

In an exemplary embodiment, the industry best practices 306 component may include information 310 generated through a series of analyses. Such analyses may include procurement spend data analysis, such as reviewing procurement metrics in view of client specific industry. The procurement metrics may include “Indirect spend per employee”, “Percentage of Indirect spend under control of purchasing department”, and “Average CPT for companies using e-invoicing”.

In an exemplary embodiment, the process 308 component may include information 314 also generated through a series of analysis. Such analysis may include a series of questions related to Procurement process flows currently in place, as well as envisaged to be implemented in future. For example, “What is the annual spend amount on indirect goods and services purchased?”, “How are the negotiations being handled?”, “What is the percentage of non-contract purchase and what are the broad categories constituting it?”, “How are invoicing, receipts and reconciliation done?”

In an exemplary embodiment, disclosed embodiments of Ariba procurement are tactically addressable. Preferred embodiments include designs for proactively reaching out to EM's/CFG's for an Ariba opportunity assessment. Additional embodiments may include a 360 degree reconnaissance of a customer's procurement ecosystem; the core of which is based on the Ariba Spend Management (ASM) engine. Opportunity assessment to build a transformation prescription is also tactically addressable. A structured and methodical framework for an Ariba Go-To-Market (GTM) team to follow may also be provided. Thus, a model is provided which builds a critical knowledge repository of procurement best practices in various industry verticals.

In an exemplary embodiment, disclosed embodiments of Ariba procurement are strategically addressable. This sets the base for framing a client's procurement roadmap. Additionally, a base may be established for turning a one-off client engagement to a long term relationship enabling a provider to partner with the client on their procurement evolution. This may also enable an SCM-Ariba group to expand its business footprint and move up the value chain. Thus, a provision of cultivating a consulting mindset in its resources and moving towards differentiation in its service offering is provided.

In an exemplary embodiment, a 360 degree rapid assessment-to-roadmap methodology driven on a dynamic Ariba dashboard is fine-tuned through ever-changing trends. In doing so, the pursuit focus of the provider may be elevated from a one-off RFX response towards a “business progression” view. This may open the door for a provider to collaborate with the client and embark on a procurement value realization journey.

Hence, business is generated due to this innovation for profit. Employee satisfaction is increased due to a value chain progression. Client satisfaction is achieved due to ASM suite's capabilities put to desired use. And by delivering high-end consulting work, the provider's brand name may be reinforced.

Thus, disclosed embodiments provide advantages, for example, to software services companies that do not have a methodology to capitalize on their tactical procurement engagements. This will provide additional advantages to software services companies that do not have a methodology to harness the critical procurement data clients share with them during RFP/RFI. Thus, the disclosed invention addresses and provides an in-place assessment-to-prescription procurement methodology that takes into account business processes, technology maturity and industry trends and best practices centered on the Ariba Spend Management (ASM) engine.

The above-described devices and subsystems of the exemplary embodiments of FIGS. 1-3 can include, for example, any suitable servers, workstations, PCs, laptop computers, PDAs, Internet appliances, handheld devices, cellular telephones, wireless devices, and the like, capable of performing the processes of the exemplary embodiments of FIGS. 1-3. The devices and subsystems of the exemplary embodiments of FIGS. 1-3 can communicate with each other using any suitable protocol and can be implemented using one or more programmed computer systems or devices.

One or more interface mechanisms can be used with the exemplary embodiments of FIGS. 1-3, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, or a combination thereof.

It is to be understood that the devices and subsystems of the exemplary embodiments of FIGS. 1-3 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-3 can be implemented via one or more programmed computer systems or devices.

To implement such variations as well as other variations, a single computer system can be programmed to perform the special purpose functions of one or more of the devices and subsystems of the exemplary embodiments of FIGS. 1-3. On the other hand, two or more programmed computer systems or devices can be substituted for any one of the devices and subsystems of the exemplary embodiments of FIGS. 1-3. Accordingly, principles and advantages of distributed processing, such as redundancy, replication, and the like, also can be implemented, as desired, to increase the robustness and performance the devices and subsystems of the exemplary embodiments of FIGS. 1-3.

The devices and subsystems of the exemplary embodiments of FIGS. 1-3 can store information relating to various processes described herein. This information can be stored in one or more memories, such as a hard disk, optical disk, magneto-optical disk, RAM, and the like, of the devices and subsystems of the exemplary embodiments of FIGS. 1-3. One or more databases of the devices and subsystems of the exemplary embodiments of FIGS. 1-3 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-3 can include appropriate data structures for storing data collected and/or generated by the processes of the devices and subsystems of the exemplary embodiments of FIGS. 1-3 in one or more databases thereof.

All or a portion of the devices and subsystems of the exemplary embodiments of FIGS. 1-3 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-3 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-3, for driving the devices and subsystems of the exemplary embodiments of FIGS. 1-3, for enabling the devices and subsystems of the exemplary embodiments of FIGS. 1-3 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-3. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-3 can include computer readable medium or memories for holding instructions programmed according to the teachings of the present invention and for holding data structures tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention has been described in connection with a number of exemplary embodiments and implementations, it is not so limited, but rather covers various modifications and equivalent arrangements, which fall within the purview of the appended claims.

What we claim is:

1. A method for providing a procurement solution, comprising:
determining a maturity level of a strategic direction, procurement processes, and procurement information technology (IT) landscape of a client;
identifying a prescription to a spend management solution product based on the determined maturity level, procurement processes, and procurement IT landscape of the client; and
deploying the spend management solution product for the client based on the identified prescription to the spend management solution product.

2. The method of claim 1, further comprising employing an interactive questionnaire for the determining of the maturity level, procurement processes, and procurement IT landscape of the client.

3. The method of claim 1, wherein the spend management solution product includes a suite of products.

4. The method of claim 3, wherein the suite of products comprise an Ariba suite of products.

5. The method of claim 1, wherein the prescription provides business value to the client.

6. The method of claim 1, further comprising performing an opportunity assessment and gap analysis of the procurement IT landscape of the client based on a service or solution offering of a service provider of the client.

7. The method of claim 6, wherein the opportunity assessment and gap analysis provides business rationale for the service provider of the client.

8. The method of claim 1, further comprising developing a knowledge base that provides an overview of IT procurement landscapes for a plurality of client industry vertical markets.

9. The method of claim 1, further comprising employing at least one of a pull component and a push component to implement one or more of the determining, identifying, and deploying steps, wherein the pull and push components are linked via a hybrid strategy.

10. The method of claim 9, wherein both the pull and push component provide information to an opportunity assessment component for producing the procurement solution.

11. The method of claim 9, wherein the push component employs information from a spend management solution product and the client, and the pull component employs information from the client and the service provider of the client.

12. The method of claim 11, wherein the spend management solution product comprises a suite of products.

13. A system for providing a procurement solution, comprising:
means for determining a maturity level of a strategic direction, procurement processes, and procurement information technology (IT) landscape of a client;
means for identifying a prescription to a spend management solution product based on the determined maturity level, procurement processes, and procurement IT landscape of the client; and
means for deploying the spend management solution product for the client based on the identified prescription to the spend management solution product.

14. The system of claim 13, further comprising an interactive questionnaire for the determining of the maturity level, procurement processes, and procurement IT landscape of the client.

15. The system of claim 13, wherein the spend management solution product includes a suite of products.

16. The system of claim 15, wherein the suite of products comprise an Ariba suite of products.

17. The system of claim 13, wherein the prescription provides business value to the client.

18. The system of claim 13, further comprising means for performing an opportunity assessment and gap analysis of the procurement IT landscape of the client based on a service or solution offering of a service provider of the client.

19. The system of claim 13, wherein the opportunity assessment and gap analysis provides business rationale for the service provider of the client.

20. The system of claim 13, further comprising a knowledge base that provides an overview of IT procurement landscapes for a plurality of client industry vertical markets.

21. The system of claim 13, further comprising at least one of a pull component and a push component to implement one or more of the determining, identifying, and deploying means, wherein the pull and push components are linked via a hybrid strategy.

22. The system of claim 21, wherein both the pull and push component provide information to an opportunity assessment component for producing the procurement solution.

23. The system of claim 21, wherein the push component employs information from a spend management solution product and the client, and the pull component employs information from the client and the service provider of the client.

24. The system of claim 23, wherein the spend management solution product comprises a suite of products.

25. A tangible computer-readable medium having stored thereon computer executable instructions for providing a procurement solution, the computer-readable medium comprising program code for performing the steps of:
determining a maturity level of a strategic direction, procurement processes, and procurement information technology (IT) landscape of a client;
identifying a prescription to a spend management solution product based on the determined maturity level, procurement processes, and procurement IT landscape of the client; and
deploying the spend management solution product for the client based on the identified prescription to the spend management solution product.

26. The computer-readable medium of claim 25, further comprising employing an interactive questionnaire for the determining of the maturity level, procurement processes, and procurement IT landscape of the client.

27. The computer-readable medium of claim 25, wherein the spend management solution product includes a suite of products.

28. The computer-readable medium of claim 27, wherein the suite of products comprise an Ariba suite of products.

29. The computer-readable medium of claim 25, wherein the prescription provides business value to the client.

30. The computer-readable medium of claim 25, further comprising performing an opportunity assessment and gap analysis of the procurement IT landscape of the client based on a service or solution offering of a service provider of the client.

31. The computer-readable medium of claim 30, wherein the opportunity assessment and gap analysis provides business rationale for the service provider of the client.

32. The computer-readable medium of claim 25, further comprising developing a knowledge base that provides an overview of IT procurement landscapes for a plurality of client industry vertical markets.

33. The computer-readable medium of claim 25, further comprising employing a pull component; and a push component to implement one or more of the determining, identifying, and deploying steps, wherein the pull and push components are linked via a hybrid strategy.

34. The computer-readable medium of claim 33, wherein both the pull and push component provide information to an opportunity assessment component for producing the procurement solution.

35. The computer-readable medium of claim 33, wherein the push component employs information from a spend management solution product and the client, and the pull component employs information from the client and the service provider of the client.

36. The computer-readable medium of claim 35, wherein the spend management solution product comprises a suite of products.
